(19) United States
(12) Patent Application Publication
(10) Pub. No.: US 2007/0162608 A1
(43) Pub. Date: Jul. 12, 2007

(54) USING SERVICES PROVIDED VIA A COMMUNICATION SYSTEM

(75) Inventors: Jari Selenius, Espoo (FI); Colin McKell-Redwood, Devizes (GB); Jouko Tenhunen, Helsinki (FI); Pekka Ketola, Tampere (FI); Mika Jussila, Jyvaskyla (FI)

Correspondence Address: FOLEY & LARDNER LLP, P.O. BOX 80278, SAN DIEGO, CA, 92138-0278, US

(73) Assignee: Nokia Corporation

(21) Appl. No.: 11/563,640

(22) Filed: Nov. 27, 2006

(30) Foreign Application Priority Data
May 25, 2004 (FI) PCT/FI04/00319

(51) Int. Cl. G06F 15/16

(52) U.S. Cl. 709/229; 348/207.1

(57) ABSTRACT

The present invention relates to a method for using services provided via a communication system. The method comprises providing user equipment with a service logic entity for interfacing a service provided via the communication network with features of the user equipment. The method further comprises configuring the service logic in a service specific manner. Furthermore, the method comprises interacting the user equipment with the service in the service specific manner using features of the user equipment. The present invention relates also to a control framework, user equipment and a service portal adapted to embodiments of the invention.

### FIELD OF THE INVENTION

The invention relates to communication systems, and more particularly to using services provided via the communication system, such as online imaging services.

### BACKGROUND OF THE INVENTION

A communication system can be seen as a facility that enables communication sessions between two or more entities such as user terminal and/or other nodes associated with the communication system. Examples of communication systems may include fixed line communication systems, such as a public switched telephone network (PSTN), wireless communication systems, e.g. global system for mobile communications (GSM), general packet radio service (GPRS), universal mobile telecommunications system (UMTS), wireless local area network (WLAN) and so on, and/or other communication networks, such as an Internet Protocol (IP) network and/or other packet switched data networks. Various communication systems may simultaneously be concerned in a connection.

A user may access a communication network by means of any appropriate user equipment (UE), for example a mobile terminal, such as a mobile station (MS), a cellular phone, a personal digital assistant (PDA) or the like, or other terminals, such as a personal computer (PC), or any other equipment operable according to a suitable network protocol, such as a hypertext transfer protocol (HTTP) or a wireless applications protocol (WAP). User equipment may be provided with an appropriate browser using human readable content markup language, such as hypertext markup language (HTML), extensible hypertext markup language (XHTML) or wireless markup language (WML).

Users of a communication system may be offered and provided numerous services, such as two-way or multi-way calls, data communication or multimedia services or simply an access to a network, such as the Internet. User equipment may support short message service (SMS), multimedia message service (MMS), electronic mail (email), Web service interface (WSI) messaging, voice mail, and so on. The services may be offered by an operator of the communication system or by another service provider providing services via the communication system.

In the fixed communication networks, services providing online imaging services, such as online printing services, network storage services and so on, have been developed. For example, a document may be sent from user equipment to a service provider providing online printing services. The service provider may allow user to configure and to preview the document online, for example by means of software (SW) in a server of the service provider. The document may then be printed by the service provider and sent to the user or to another addressee selected by the user. In another example, documents of a user are stored in a network storage provided by a service provider. The user may select one or more documents to be printed and the selected document(s) are printed and delivered by the service provider. Typically, this kind of service may be provided by an online imaging service provider, such as a photo lab or the like. Each online imaging service provider may have its own software and system to provide the service. Each software may have to be downloaded to the user equipment.

Small size and data transfer technology in the mobile communication systems may create problems and challenges in retrieving services provided via communication systems. For example, using online imaging services with a mobile station or mobile handset as an end terminal may be inconvenient. Current methods rely on the user using a specific pre-installed or downloadable add-on application or an HTML browser, assuming one exists in the mobile handset, and then downloading services. Online imaging services functioning via specific pre-installed or downloadable add-on applications or HTML browsers have been designed for the PC environment and have been modified for use in a mobile environment. This may result in a poor user experience. Furthermore, an independent service provider typically provides a service independently. The interoperability with user equipment tends to be taken into account only in extend necessary to make the service functioning, without paying any attention to compatibility with other applications in the user equipment.

Therefore, there is a need to provide improved tools for using online services, such as online imaging services or the like, in particular within the mobile environment. It may be desirable to ameliorate ease of use and user experience. It may also be desirable to improve the use of memory capacity in user equipment.

### SUMMARY OF THE INVENTION

In accordance with an aspect of the invention, there is provided a method for using services provided via a communication system. The method comprises providing user equipment with a service logic entity for interfacing a service provided via the communication network with features of the user equipment. The method further comprises configuring the service logic in a service specific manner. Furthermore, the method comprises interacting the user equipment with the service in the service specific manner using features of the user equipment.

In accordance with a further aspect of the invention, there is provided a control framework. The control framework comprises a service logic entity in user equipment for interfacing a service provided via a communication network with features of the user equipment. Furthermore, the control framework comprises a configuration entity for configuring the service logic in a service specific manner. The control framework enables the user equipment to interact with the service in the service specific manner using features of the user equipment.

In accordance with a further aspect of the invention, there is provided user equipment comprising such a control framework.

In accordance with a further aspect of the invention, there is provided a service portal configured to group services provided via a communication network for presenting to a user of user equipment, to provide the user equipment with a configuration entity for configuring a service logic in the user equipment in a service specific manner specific for at least one of the services comprised in the group and to allow the user equipment to interact with the service by means of the service logic of the user equipment in the service specific manner using features of the user equipment.

In an embodiment, the service logic entity may interface a service comprising a group of individual services with the features of the user equipment.

In an embodiment, the configuration entity may comprise a configuration file comprising static parameters relating to the service and dynamical parameters changeable upon use of the service. The static parameters may comprise user interface elements for rendering the user interface according to settings provided by the service provider. The dynamical parameters may comprise information on the use of the service.

In an embodiment, the configuration entity may enable requesting from a user of the user equipment information on the service.

In an embodiment, at least a part of information comprised in the configuration entity may be passed into a second configuration entity replacing said configuration entity.

### BRIEF DESCRIPTION OF THE DRAWINGS

The invention will now be described in further detail, by way of example only, with reference to the following examples and accompanying drawings, in which:

FIG. 1 shows an example of a system in which the embodiments of the invention may be implemented; and

FIG. 2 shows an embodiment of the invention.

### DETAILED DESCRIPTION OF PREFERRED EMBODIMENTS

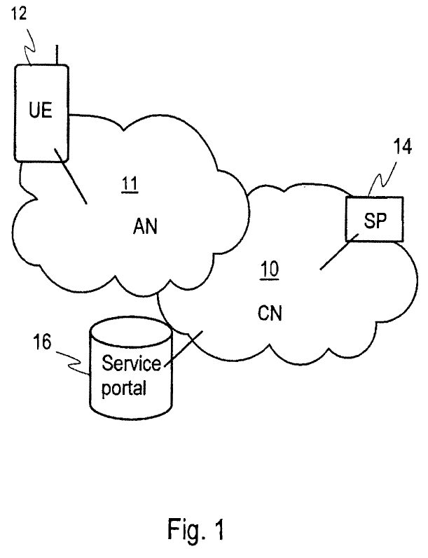

FIG. 1 shows an example of a network architecture in which the embodiments of the invention may be implemented. FIG. 1 shows a communication network (CN) 10, an access network (AN) 11, user equipment (UE) 12 and a server of a service provider (SP) 14. In the arrangement of FIG. 1, the user equipment 12 may access the communication network 10 via the access network 11 or an access link. Examples of possible access networks and access links may comprise, but are not limited to a cellular network, e.g. a GPRS network, a wireless local area network (WLAN), Bluetooth connection and so on. The communication network 10 may be provided at least in part by means of an IP network, such as the Internet. Furthermore, a service portal 16 is shown in FIG. 1. The service portal 16 may be a server common to a plurality of services. Function of the exemplifying service portal 16 will become clear from the following description.

It shall be appreciated that, although for clarity reasons FIG. 1 shows only one user equipment, one server of a service provider and one access network, a typical communication network system usually includes a number of these entities. Depending on the communication system, the terminology used in connection with entities having similar function may also vary.

The present invention provides a control framework, preferably resident in mobile user equipment, such as a mobile station. The control framework may be embedded in appropriate location in the user equipment, such as in an image gallery application of the user equipment. In an alternative, the control framework may be embedded in another application in the user equipment and used through a standard Application Programming Interface (API) of the user equipment. The control framework provides a platform in the user equipment enabling functioning in accordance with requirements of the user equipment and/or settings of the user and, at the same time, enabling service providers to provide their services in accordance with requirements and/or settings of each service provider. The control framework consists of a plurality of native or add-on functionalities with APIs, through which functionalities of the user equipment may be accessed. Such functionalities may include, but are not limited to, an application interworking interface in the user equipment, connectivity software components, other applications, such as Wallet application, Contact Book application, Media Manager application, camera client, MMS client and so on.

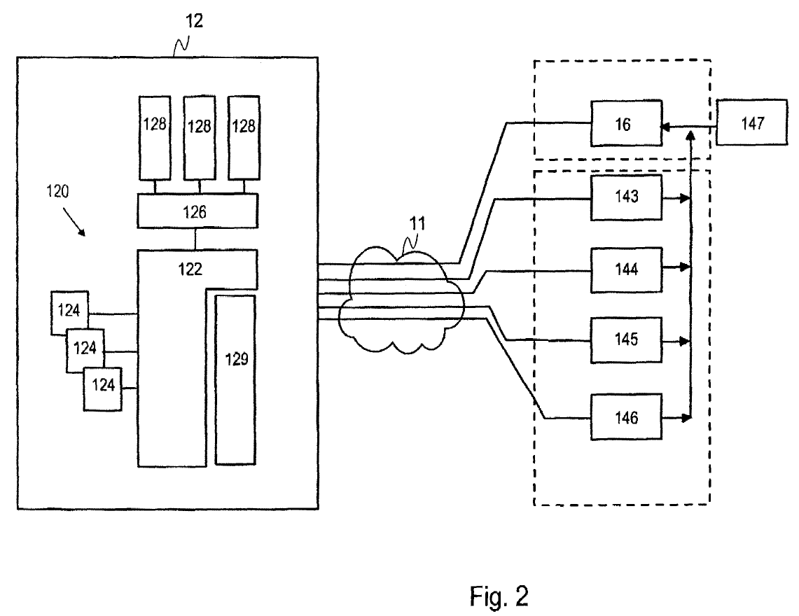

FIG. 2 shows an exemplifying control framework 120 provided in user equipment 12 connected to servers 143, 144, 145, 146 of service providers and to a service portal 16. The control framework 120 is connected to the servers 143, 144, 145, 146 and to the service portal 16 via a communication system, for example, as shown in FIG. 1. The connection may be routed via an access network 11 comprising an access node, such as a gateway GPRS support node or a performance enhancing proxy. The access node may comprise both chargeable access points and free access points depending, for example, on the type of service.

The control framework 120 may comprise at least one service logic entity 122, also called a plug-in, at least one configuration entity or configuration file 124 and control framework's common functionalities 129, such as an HTTP uploader and so on.

The service logic entity 122 is a resident or downloadable block for implementing functionalities of services in user equipment and for interfacing with user equipment features or software. The service logic 122 may utilise generic functionalities and applications 128 of the user equipment through an application interworking interface 126. The service logic 122 provides application logic and may contain parameters relating to the user equipment, end-user preferences and the service provider. There may be a plurality of service logic entities 122, for example one service logic entity for each service category. A service category is a category providing a certain type of service and may be configured by multiple service providers, as will be explained in the following.

The configuration entity or configuration file 124 is a resident or downloadable block for providing parameters to the service logic 122 of the user equipment permitting the user to operate the user equipment features in a manner defined by a third party, such as a service provider. Thus, the configuration file 124 may be used for configuring the service logic entity 122 to function in a service provider specific manner, such as a service provider providing an online imaging service and hosting a server 143, 144, 145, 146 for the service. There may be a plurality of configuration files 124, each configuration file relating to a different service provider and/or a plurality of configuration files relating to a service provider. As was mentioned above, a service category is hosted in a service logic entity and may be configured by multiple service providers, i.e. using multiple configuration files, for example one configuration file per each service within one service category. Examples of service categories may include, but are not limited to, printing service category, network storage category, file sharing category, and so on.

The configuration file(s) 124 may permit the user to interact via the control framework 120 with a server 143, 144, 145, 146 as defined within the configuration file 124 by the third party. Interaction may be realised by means of embedded service activation links and application to use the service, such as online imaging service. For example, the control framework 120 may be provided by browser-type functionality in the user equipment. Interaction may include, but is not limited to, receiving updated configuration files, promotional material, and so on.

Servers 143, 144, 145, 146 may be servers of only one service provider or of a plurality of service providers, such as different photo labs. Blocks denoting servers 143, 144, 145, 146 in FIG. 2 may comprise a server common to a service category or a server of one service provider. For example, in an online imaging service embodiment, servers 143, 144, 145, 146 may provide, but are not limited to, online album service for storing files, such as image files, online printing service for printing files, online Weblog service for sharing files with other users, and so on.

In an embodiment, a service portal 16 may be provided as a common platform for service providers to offer their services. The service portal 16 may be provided by an operator of the communication network 10 or by another appropriate service provider. The service portal 16 may also receive material from other sources 147 to be presented to the user. Protocols used for operation between the service portal 16 and a client counterpart in the user equipment 12 may comprise HTTP, WAP, XHTML and other appropriate protocols.

The service portal 16 may provide information, such as configuration files, on individual services. Furthermore, the service portal 16 may group the services in different groups such as selected service categories, selected service providers, all available service providers in a service category and so on. The information provided by the service portal 16 may be viewed and used by a user of the user equipment via the access network and the communication network 10 and may be transmitted to the user equipment 12 on a request from the user equipment. In an embodiment, the service portal 16 may be introduced to the control framework as an independent server, which needs not to be tied to a particular online service.

In an embodiment, services 143, 144, 145, 146 may be directly in connection with the user equipment 12. A service link and respective configuration file may be pre-installed in the user equipment. The user may be displayed and allowed to select a service link, for example, in the Media Manager application.

The service logic entity 122 and the configuration file(s) 124 may be provided by different parties, such as user equipment manufacturer or service providers. For example, the service logic entity 122 may be installed in user equipment 12 during manufacture or downloaded later. A service logic entity 122 may be downloaded for each service category, for example.

In an embodiment, the service logic entity 122 may be provided by a third party, such as a service provider. In that case, it may be third party dependent whether any other service provider is allowed to customize the service with their own configuration file.

A configuration file 124 may be downloaded any time and for each service. The configuration files may be downloaded from the service portal 16 or a server 143, 144, 145, 146 of a service provider using appropriate protocols, such as the HTTP.

The configuration file preferably contains parameters only. Parameters may comprise numbers, text or other character strings. Also for example images, icons and so on can be provided as parameters. In particular, image parameters may be used for example for user interface (UI) rendering purposes.

Parameters of the configuration file may be divided in core parameters and dynamical parameters. The core parameters may be static, such as provided by a service provider by the time of activating a configuration file relating to a service of the service provider. The dynamical parameters may be changed during the lifetime of the configuration file. Preferably, the latest parameter information is stored in the configuration file. The latest parameter information may also comprise a list of latest parameters, which is handled, for example, following the first-in-first-out principle.

The core parameters may comprise user interface (UI) elements, such as icons, for rendering the UI according to settings provided by the service provider, such as wishes or requirements of the service provider. Furthermore, the core parameters may comprise information, which allows a user to contact the service provider, such as an uniform resource locator (URL) address. UI elements may be rendered into predefined placeholders on then screen. Furthermore, the core parameters may comprise menu items for enabling the service provider to provide information, such as service names, in pull-down menus of the user equipment. Other appropriate core parameters may be included, as is clear from this specification.

The dynamical parameters may comprise information on the service use. Examples may comprise, but are not limited to, stating that a certain special offer has been used and shall not be available any more, or an order history, for example, in a first-in-first-out list of previous orders. Other appropriate dynamical parameters may be included, as is clear from this specification. Dynamical parameters may be changed and updated by a user, for example, by means of input-output devices relating to the user equipment. In an embodiment, an application in the user equipment may change and update the dynamical parameters automatically and/or in response to an occurrence, such as use of a service. Dynamical parameters may also be changed and updated by the service provider, for example, by transmitting information from the server to the user equipment.

Some of the core and dynamical parameters may be defined as mandatory for enabling service. Some of the parameters may be defined as optional. An example of the mandatory parameters may include, but is not limited to, service address, without which the respective server cannot be accessed.

Since the exact behaviour of a service provided by a service provider is not known in advance, the configuration file may provide a mechanism to request service provider specific information from the user. Associated with the service provider specific information a bullet item list may be provided. With the bullet item list the service provider can provide the each other exclusionary alternatives for the service provider specific information. This way the user can be requested for selecting information on item for which only one value at the time may be accepted. For example, the bullet item list may be used to select an image size from a list of available image sizes or a size of a T-shirt if the user orders a T-shirt with a printed image.

Status, i.e. existence, non-existence or a value, of a parameter in a configuration file may have influence to other parameters within the same configuration file. Furthermore, the behaviour of the application, which is controlled with the configuration file, may also be influenced depending on the status of the parameters.

Typically, a configuration file may have parameters that have been set by the user, in particular in the dynamical part of the configuration file. By the time of upgrading the configuration file with a new version, some parameters, such as some of the parameters set by the users and other appropriate parameters, can be inherited by the new version, which replaces the old version.

The information of configuration files may be distributed in various formats. By distributing the configuration file information, for example, in .sis-files, a parallel version control mechanism may not be needed. However, in distributing the information in the form of .sis-files, the inheritance of dynamical parts of the configuration file may need to be arranged on the application level. In an embodiment, the information of configuration files may be distributed in .xml files.

An example of possible configuration file parameters according to an embodiment of the invention is given in Table 1. It shall be appreciated that the set of parameters given in Table 1 is only an illustrating example of an embodiment. The number and nature of parameters may vary depending on the service type, user equipment, communication system and various other such features.

TABLE 1
An exemplifying set of parameters within a configuration
file according to an embodiment of the invention.

| | | Core/ | | |
|---|---|---|---|---|
| # | Parameter name | Dynamic | Type | Optionality |
| 1 | Service Category | Core | number | Mandatory |
| 2 | Sub-service category | Core | number | May be necessary |
| | | | | extension? |
| 3 | Version number | Core | number | Mandatory |
| | | | | (maybe provided |
| | | | | by the versioning |
| | | | | of .sis files) |
| 4 | Service address | Core | URL | Mandatory |
| 5 | Authentication & | Core | ? | Mandatory |
| | Authorization | | | |
| 6 | Skin: Service provider's | Core | icon | Mandatory |
| | logo | | | |
| 7 | Skin: Name of the SP's | Core | text | Mandatory |
| | service | | (+font?) | |
| 8 | Skin: Other SP specific | Core | Skin? | Optional |
| | rendering | | | |
| 9 | Menu item name | Core | text | Mandatory |
| 10 | Information sheet | Core | text/& | Optional |
| | | | images? | |
| 11 | Purpose of the “# | Core | text | Default: “Number |
| | extension” | | | of copies” |
| 12 | Radio buttons of the “# | Core | choice list | Optional |
| | extension” | | | |
| 13 | Help data | Core | text/& | Optional |
| | | | images? | |
| 14 | Minimum number of | Core | number | Optional |
| | images | | | |
| 15 | Maximum number of | Core | number | Optional |
| | images | | | |
| 16 | Delivery address | Dyn | address | Mandatory before |
| | | | | use |
| 17 | Charging method | Dyn | selection | Mandatory before |
| | | | | use |
| 18 | Charged address | Dyn | address | Mandatory before |
| | | | | use |
| 19 | Order history | Dyn | text/& | Optional |
| | | | images? | |
| 20 | Validity of an E-coupon | Dyn | ? | Optional |

The present invention may provide means for reducing the need for memory capacity in user equipment compared to a situation that all service providers provide their services independently in full. Using a configuration file according to embodiments of the present invention may eliminate a need to introduce new software within a service category and no programming skills are needed in the service provider's side. Integration with existing applications in a user terminal may be improved and made quicker and easier, also including required user interface changes. The present invention may provide forward-looking capability to expect such information from the user which is not known by the time of creating the baseline application. Inheritable information may be directly transferred from an old or current version to a new version, thus reducing need to type information. Users may be provided with services having functional feel familiar from or characteristic of the other application in the device, however allowing services customised with any service providers own brand and service portfolio.

Although the invention has been described in the context of particular embodiments, various modifications are possible without departing from the scope and spirit of the invention as defined by the appended claims. It should be appreciated that whilst embodiments of the present invention have mainly been described in relation to mobile user equipment such as mobile terminals, embodiments of the present invention may be applicable to other types of user equipment that may access communication networks. Furthermore, the communication system may be any appropriate communication system, even if reference has mainly been made to mobile communication systems.

1. A method for using services provided via a communication system, the method comprising:
providing user equipment with a service logic entity for interfacing a service provided via the communication network with features of the user equipment;
configuring the service logic in a service specific manner; and
interacting the user equipment with the service in the service specific manner using features of the user equipment.

2. A method according to claim 1, wherein configuring comprises receiving a configuration file from the service.

3. A method according to claim 1, wherein configuring comprises receiving a configuration file from a service portal common to a plurality of services.

4. A method according to any of claim 1, wherein configuring comprises receiving parameters comprising static parameters relating to the service and dynamical parameters changeable upon use of the service.

5. A computer program comprising program code embodied in a computer readable medium the computer program code configured for performing the method of claim 1.

6. A control framework comprising:
a service logic entity in user equipment for interfacing a service provided via a communication network with features of the user equipment;
a configuration entity for configuring the service logic in a service specific manner, the control framework enabling the user equipment to interact with the service in the service specific manner using features of the user equipment.

7. A control framework according to claim 6, wherein the service logic entity interfaces a service comprising a group of individual services with the features of the user equipment.

8. A control framework according to claim 6, wherein the configuration entity comprises a configuration file comprising static parameters relating to the service and dynamical parameters changeable upon use of the service.

9. A control framework according to claim 8, wherein the static parameters comprise user interface elements for rendering the user interface according to settings provided by the service provider.

10. A control framework according to claim 8, wherein the dynamical parameters comprise information on the use of the service.

11. A control framework according to any of claim 6, wherein the configuration entity enables requesting from a user of the user equipment information on the service.

12. A control framework according to any of claim 6, wherein at least a part of information comprised in the configuration entity is passable into a second configuration entity replacing said configuration entity.

13. A control framework according to any of claim 6, wherein the configuration entity comprises a .sis-file or a .xml-file.

14. A control framework configured to:
provide user equipment with a service logic entity for interfacing a service provided via a communication network with features of the user equipment;
configure the service logic in a service specific manner; and
interact the user equipment with the service in the service specific manner using features of the user equipment.

15. User equipment comprising the control framework according to claim 6.

16. User equipment comprising a control framework, the control framework comprising:
at least one service logic entity for interfacing a service provided via a communication network with features of the user equipment;
a configuration entity for configuring the service logic in a service specific manner, the control framework enabling the user equipment to interact with the service in the service specific manner using features of the user equipment.

17. A service portal configured to:
group services provided via a communication network for presenting to a user of user equipment;
provide the user equipment with a configuration entity for configuring a service logic in the user equipment in a service specific manner specific for at least one of the services comprised in the group; and
allow the user equipment to interact with the service by means of the service logic of the user equipment in the service specific manner using features of the user equipment.

18. A computer program comprising program code embodied in a computer readable medium, the computer program code configured for performing the method of claim 2.

19. A computer program comprising program code embodied in a computer readable medium, the computer program code configured for performing the method of claim 3.

20. A computer program comprising program code embodied in a computer readable medium, the computer program code configured for performing the method of claim 4.
